(19) United States
(12) Patent Application Publication
(10) Pub. No.: US 2008/0022312 A1
(43) Pub. Date: Jan. 24, 2008

(54) Method and apparatus for displaying personal schedules on a television

(75) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/489,357

(22) Filed: Jul. 19, 2006

(51) Int. Cl. G06F 13/00; G06F 3/00; H04N 7/16; H04N 5/445; H04N 7/18

(52) U.S. Cl. 725/58; 725/39; 725/62; 725/46; 725/81

(57) ABSTRACT

A method of displaying a user's personal schedule on a television set is provided. The method comprises receiving the user's personal schedule via a scheduling program residing on a personal computer, wherein the personal computer is networked with the television set; determining whether a scheduled event for the user is coming up; retrieving the scheduled event information and sending it over to the television set via a network interface between the computer and the television set; and displaying the scheduled event information on the television set without interrupting the current television program.

### BACKGROUND OF THE INVENTION

This invention relates to a method and apparatus for retrieving a stored personal schedule from a networked computer and displaying it on a television screen.

While the invention is particularly directed to the art of telecommunications, and will be thus described with specific reference thereto, it will be appreciated that the invention may have usefulness in other fields and applications.

By way of background, many people are utilizing various types of electronic methods for recording and maintaining their personal schedules. For instance, well known software such as Microsoft Outlook and Lotus Notes allows users to save personal schedules on a personal computer (PC).

Electronic scheduling is not limited to personal computers, however. Personal digital assistants (PDAs) are becoming more popular. PDAs are small, hand-held computers that are used for storing, manipulating and retrieving data. At least three different types of PDAs exist today: the organizer with some PC features (e.g., Palm); the handheld PC with organizer features (e.g., Pocket PC); and the wireless e-mail/pager with organizer features (e.g., RIM BlackBerry). PDAs provide a variety of functions, such as an electronic day planner, an address book, a “to do” list, and a memo pad. Data may be shared between the PDA and the personal computer.

However, users may not want to be limited to using their PDA or their personal computer to view their personal schedules. For instance, people are spending more time watching television for both educational purposes and entertainment. It is very likely that people may forget or miss their important appointments because of watching television programs. It will be very helpful if a scheduled event can pop up on the television screen and serve as a reminder. This is also very convenient because people do not need to look up their schedules from a personal computer or PDA device while viewing TV programs. Thus, the present invention contemplates a new and improved method that resolves the above-referenced difficulties and others.

### SUMMARY OF THE INVENTION

A method and apparatus for displaying a user's personal schedule on a television set are provided.

In one aspect of the invention a method of displaying a user's personal schedule on a television set is provided. The method comprises receiving the user's personal schedule and storing the user's personal schedule in a contact database residing on a personal computer, wherein the personal computer is networked with one or more television sets; determining whether a scheduled event for the user is coming up; retrieving information concerning the scheduled event from the contact database; and transferring the scheduled event information to at least one of the television sets in a given data format via a network interface between the personal computer and the one or more television sets.

In another aspect of the invention an apparatus for displaying a user's personal schedule on a television set is provided. The apparatus comprises receiving means for receiving the user's personal schedule and storing the user's personal schedule in a contact database residing on a personal computer, wherein the personal computer is networked with one or more television sets; determining means for determining whether a scheduled event for the user is coming up; retrieving means for retrieving information concerning the scheduled event from the contact database; and transferring means for transferring the scheduled event information to at least one of the television sets in a given data format via a network interface between the personal computer and the one or more television sets.

In yet another aspect of the invention an article of manufacture for use in a computer system having an operating system is provided. The article of manufacture comprises a computer usable medium having computer readable program code means embodied thereon for causing a user's personal schedule to be displayed on a television set. The computer readable program code means comprises: computer readable program code means embodied in said computer usable medium for causing the computer system to receive the user's personal schedule; computer readable program code means embodied in said computer usable medium for causing the computer system to store the user's personal schedule in a contact database; computer readable program code means embodied in said computer usable medium for causing the computer system to determine whether a scheduled event for the user is coming up; computer readable program code means embodied in said computer usable medium for causing the computer system to retrieve information concerning the scheduled event from the contact database; and computer readable program code means embodied in said computer usable medium for causing the computer system to transfer the scheduled event information to at least one of the television sets in a given data format via a network interface between the personal computer and the one or more television sets.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of a telecommunications system suitable for implementing aspects of the present invention; and

FIG. 2 is a flowchart of a method of displaying personal schedules on a television in accordance with aspects of the present invention.

### DETAILED DESCRIPTION

A method and apparatus for displaying a user's personal schedule on a television set is described. Some portions of the detailed description that follows are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems will be apparent from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

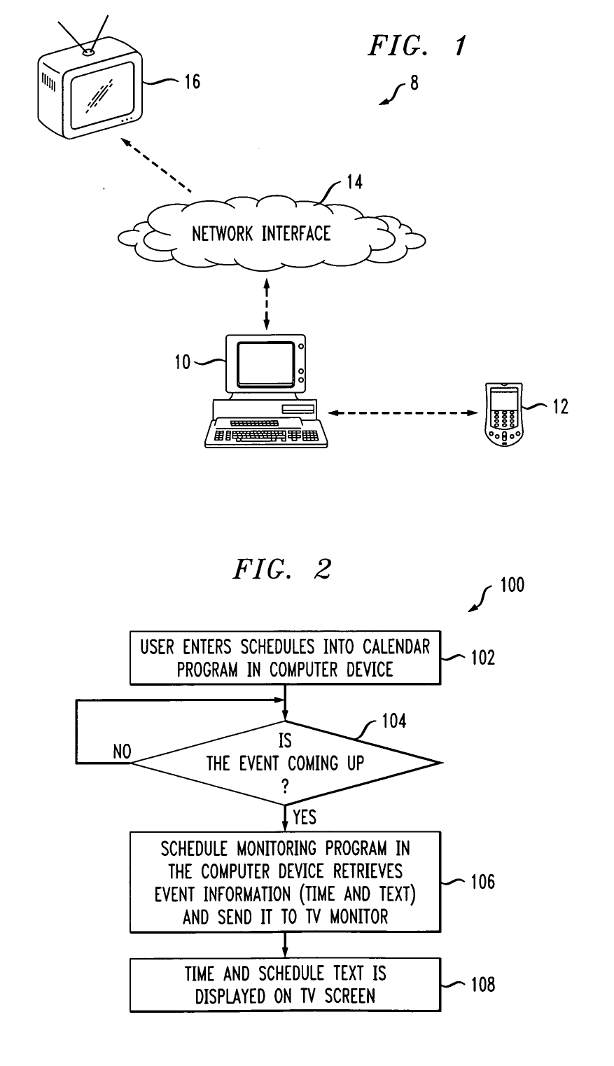

Referring now to the drawings wherein the showings are for purposes of illustrating the exemplary embodiments only and not for purposes of limiting the claimed subject matter, FIG. 1 provides a view of a system 8 into which the presently described embodiments may be incorporated. As shown generally, FIG. 1 includes a personal computer 10, an optional handheld scheduling device 12 such as a PDA or mobile phone, and a network interface 14 for transferring the retrieved schedule information to a television set (or TV) 16. Although only a single TV 16 is shown in FIG. 1, it is to be understood that there may be multiple TVs in the system 2.

The PDA 12 may be any personal digital assistant, such as any of the Palm series by Palm, Inc., a Pocket PC, any of the BlackBerry series by Research in Motion (RIM) or another type of PDA. Generally, PDAs store data in proprietary formats. The PDA 12 can communicate with a computer system, with another PDA, and with other devices, either by being coupled to the other device by a cable or transmitting information via infrared, radio, or other wireless transmission, as described more fully below. The PDA 12 is generally not modified and transmits its information, whether via cable/socket connection or via beaming, in its native format.

The PC 10 and the PDA 12 may incorporate wireless and multimedia functions of some type. Functions found on these (but not necessarily all) devices include, for example, short-range wireless connectivity using Infrared (IR) or Bluetooth technology IR, which is commonly used to sync with a notebook computer that has an IR port. Bluetooth wirelessly connects to other Bluetooth-enabled devices, such as a headset or a printer. The PC 10 and the PDA 12 may also include Internet and network connectivity through Wi-Fi and wireless access points as well as support for Wireless WAN (Wide Area Networks), the cellular data networks that provide Internet connectivity for smart phone devices.

Thus, the PC 10 and the PDA 12 may include means such as IEEE 802.11 Wireless Ethernet, IEEE 802.3 Ethernet, HiperLan, Universal Serial Bus (USB), RS-232 serial ports, Bluetooth, wired telephone modems, cellular wireless, and IEEE 11.1R communications ports for connecting the devices to other devices and networks.

These communications ports are all based on standards and technologies known in the computer and/or communications arts. For example, IEEE 802.11 refers to a family of specifications developed by the Institute of Electrical and Electronics Engineers for wireless Local Area Network technology. IEEE 802.11 specifies an over-the-air interface between a wireless client and a base station or between two wireless clients. There are several specifications in the 802.11 family. 802.11 applies to wireless LANs and provides 1 or 2 Mbps transmission in the 2.4 GHz RF band using either frequency hopping spread spectrum (FHSS) or direct sequence spread spectrum (DSSS). IEEE 802.11a is an extension to 802.11 that applies to wireless LANs and provides up to 54 Mbps in the 5 GHz band. 802.11a uses an orthogonal frequency division multiplexing encoding scheme rather than FHSS or DSSS. IEEE 802.11b (also referred to as 802.11 High Rate or Wi-Fi) is an extension to 802.11 that applies to wireless LANS and provides 11 Mbps transmission (with a fallback to 5.5, 2 and 1 Mbps) in the 2.4 GHz band. 802.11b uses only DSSS. 802.11b was a 1999 ratification to the original 802.11 standard, allowing wireless functionality comparable to Ethernet. IEEE 802.11 g. applies to wireless LANs and provides 20+Mbps in the 2.4 GHz band.

Bluetooth refers to a short-range radio technology aimed at simplifying communications among Net devices and between devices and the Internet. It also aims to simplify data synchronization between Net devices and other computers. Products with Bluetooth technology must be qualified and pass interoperability testing by the Bluetooth Special Interest Group prior to release. The Bluetooth 1.0 specification consists of two documents: the Foundation Core, which provides design specifications, and the Foundation Profile, which provides interoperability guidelines. These provisions for connectivity can greatly enhance the usefulness of these devices.

Data that is shared between the PDA 12 and the personal computer (desktop or laptop) 10 must be periodically synchronized. Generally, the user physically attaches the PDA 12 to the desktop or laptop computer 10 to insure that the latest versions of a document or database are present on both machines. A contact database and scheduling program (e.g., Microsoft Outlook, Lotus Notes, etc.) hosted on the personal computer 10 lets the user see the information needed to get in touch with others, and it shows the schedules of others so that meetings and appointments are managed more efficiently. The data synchronized ensures that the PDA 12 has an accurate list of contacts, appointments and e-mails, allowing the user to access the same information on the PDA 12 as the host computer 10. This is done through synchronization software provided with the PDA 12, such as HotSync Manager, which comes with Palm OS handhelds, or Microsoft ActiveSync, which comes with Windows Mobile handhelds.

For example, the BlackBerry PDA comes with the Desktop Manager program, which can synchronize to both Microsoft Outlook and ACT!. Other PDAs come only with their own proprietary software. Third-party synchronization software is also available for many PDAs from companies like Intellisync and CompanionLink. This software synchronizes these handhelds to other personal information managers that are not supported by the PDA manufacturers, such as GoldMine and Lotus Notes.

The personal computer 10 is connected to the TV 16 via the network interface 14. Each TV 16 may be identified, for example, by its IP address. The network interface 14 may utilize a common technology such as TCP/IP protocol. TCP/IP refers to the collection (or suite) of networking protocols that have been used to construct the global Internet. Other core protocols in the suite are UDP and ICMP. These protocols work together to provide a basic networking framework that is used by many different application protocols, each tuned to achieving a particular goal.

However, TCP/IP protocols are not used only on the Internet. They are also widely used to build private networks, or intranets, such as the system 8 shown in FIG. 1. All of the protocols in the TCP/IP suite are managed by the Internet Engineering Steering Group (IESG) based on recommendations from the Internet Engineering Task Force (IETF). More information about IESG and IETF activities can be found, for example, at the IETF Website (http://www.ieff.org/). The network interface 14 could be any home network interface, including a wireless WI-FI in-home network.

The TV 16 has the capability of displaying the user's personal schedule on its screen. A software application for converting the data received from the personal computer 10 and displaying it on the TV screen may reside in the TV itself or in a cable box, for example. The TV 16 may include display features such as Picture-in-Picture (PiP), which allows the user to watch more than one TV program (channel) at the same time on TVs or other devices. With the PiP feature, one program may be displayed on the entire TV screen and another program or programs may be displayed in one or more individual smaller squares on the screen. Picture-in-Picture is a function of the TV 16 that requires two independent tuners to supply the large and the small picture. Two-tuner PiP TVs have a second tuner built in for this purpose, single tuner PiP TVs, however, require the use of an “external tuner” to provide the second signal. In some cases, cable boxes with composite video outputs are used.

In accordance with the present invention, data must be exchanged between the personal computer 12 and TV 16. Suitable data formats include, for example, XML, HTML, and Java. Those are the typical examples and are well known in the art. The Extensible Markup Language (XML) is a W3C-recommended general-purpose markup language for creating special-purpose markup languages, capable of describing many different kinds of data. In other words XML is a way of describing data and an XML file can contain the data too, as in a database. It is a simplified subset of Standard Generalized Markup Language (SGML). Its primary purpose is to facilitate the sharing of data across different systems, particularly systems connected via the Internet. Languages based on XML are defined in a formal way, allowing programs to modify and validate documents in these languages without prior knowledge of their particular form. The Hyper Text Markup Language (HTML) is the coding language used to create hypertext documents for the World Wide Web. In the Java programming language, all source code is first written in plain text files ending with the .java extension. Those source files are then compiled into class files by the Java compiler (javac). A class file does not contain code that is native to the processor; it instead contains bytecodes—the machine language of the Java Virtual Machine. The Java launcher tool (java) then runs the application with an instance of the Java Virtual Machine.

A method 100 of retrieving the stored personal schedules from a networked computer device and displaying the schedule information on the TV screen is shown in FIG. 2. Initially, the user enters a personal schedule through the scheduler/calendar program residing on the personal computer 10, which is networked with the TV 16 (102). The user's personal schedule is stored in the contact database. The personal schedule may also be maintained in the handheld device 12, which is periodically synchronized with the computer 10.

When the user is watching a television program, data may be exchanged between the personal computer 10 and the TV 16. As explained earlier, data may be exchanged in any suitable format, including XML, HTML, or Java. While the user is watching the television program, a determination is made as to whether a scheduled event for the user is coming up (104). If a scheduled event is coming up, then the schedule monitoring program in the personal computer 10 will retrieve the event information from the contact database and transfer the scheduled event information to the TV 16 using the existing networked interface 14 between the computer 10 and the TV 16 (106). Of course, it is to be understood that the scheduled event information could be transferred to more than one TV 16, depending on how many TVs are networked together and how many are on at the time. If the schedule reminder capability is enabled on the TV 16, then the scheduled event information (time and event description) will be displayed on the TV screen without interrupting the current program (108). Of course, if no scheduled event is coming up, then no action is taken.

There can be a new menu selection item for the schedule reminder in the TV controller. For example, select “menu”->“display schedule” from the TV controller to display the user's schedule (daily, weekly, etc.) on demand.

This invention also provides capability to display all the appointments for the day when the TV is first turned on, which serves as a convenient reminder for the users.

The invention would also allow the user to designate which TV(s) in the house would show a specific family member's schedule.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of displaying a user's personal schedule on a television set comprising:
receiving the user's personal schedule and storing the user's personal schedule in a contact database residing on a personal computer, wherein the personal computer is networked with one or more television sets;
determining whether a scheduled event for the user is coming up;
retrieving information concerning the scheduled event from the contact database; and
transferring the scheduled event information to at least one of the television sets in a given data format via a network interface between the personal computer and the one or more television sets.

2. The method defined in claim 1, further comprising displaying the scheduled event information on one or more television sets without interrupting a current television program being shown on the one or more television sets.

3. The method defined in claim 1, wherein the user's personal schedule is also stored in a handheld device that is periodically synchronized with the personal computer.

4. The method defined in claim 3, wherein the handheld device comprises a Palm device, a Pocket PC or BlackBerry device.

5. The method defined in claim 1, wherein the given data format comprises XML, HTML or Java.

6. The method defined in claim 1, further comprising displaying the user's personal schedule for the day when a designated television set is first turned on.

7. An apparatus for displaying a user's personal schedule on a television set comprising:
receiving means for receiving the user's personal schedule and storing the user's personal schedule in a contact database residing on a personal computer, wherein the personal computer is networked with one or more television sets;
determining means for determining whether a scheduled event for the user is coming up;
retrieving means for retrieving information concerning the scheduled event from the contact database; and
transferring means for transferring the scheduled event information to at least one of the television sets in a given data format via a network interface between the personal computer and the one or more television sets.

8. The apparatus defined in claim 7, further comprising displaying means for displaying the scheduled event information on the television set without interrupting the current television program.

9. The apparatus defined in claim 7, wherein the user's personal schedule is also stored in a handheld device that is periodically synchronized with the personal computer.

10. The apparatus defined in claim 7, wherein the handheld device comprises a Palm device, a Pocket PC or BlackBerry device.

11. The apparatus defined in claim 10, wherein the given data format comprises XML, HTML or Java.

12. An article of manufacture for use in a computer system having an operating system, the article of manufacture comprising a computer usable medium having computer readable program code means embodied thereon for causing a user's personal schedule to be displayed on a television set, the computer readable program code means comprising:
computer readable program code means embodied in said computer usable medium for causing the computer system to receive the user's personal schedule;
computer readable program code means embodied in said computer usable medium for causing the computer system to store the user's personal schedule in a contact database;
computer readable program code means embodied in said computer usable medium for causing the computer system to determine whether a scheduled event for the user is coming up;
computer readable program code means embodied in said computer usable medium for causing the computer system to retrieve information concerning the scheduled event from the contact database; and
computer readable program code means embodied in said computer usable medium for causing the computer system to transfer the scheduled event information to at least one of the television sets in a given data format via a network interface between the personal computer and the one or more television sets.
